(19) United States
(12) Patent Application Publication
(10) Pub. No.: US 2007/0009234 A1
(43) Pub. Date: Jan. 11, 2007

(54) Using content identifiers to download cd-cover pictures to present audio content items

(75) Inventor: Bartel Marinus Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/574,136

(22) PCT Filed: Sep. 27, 2004
(86) PCT No.: PCT/IB04/51883

§ 371 Date: Mar. 29, 2006

Related U.S. Application Data
(60) Provisional application No. 60/507,285, filed on Sep. 30, 2003.

(51) Int. Cl. H04N 7/00

(52) U.S. Cl. 386/96

(57) ABSTRACT

A method for displaying a pictorial item corresponding to an audio content item is provided. The method including: identifying one or more characteristics of the audio content item; searching a remote network (114) for the corresponding pictorial item based on the identified one or more characteristics; retrieving the corresponding pictorial item from the remote network; and displaying the pictorial item corresponding to the audio content item.

The present invention relates generally to interactive systems for storing and/or playing audio content, and more particularly, to interactive systems that use content identifiers to download pictorial items, such as CD cover pictures to represent audio content items.

Interactive systems are known in the art for storing and playing audio content items, such as songs, speeches, spoken novels and the like. The interactive systems can include a personal computer, laptop computer, or audio content players such as a CD player, MP3 player, a personal digital assistant, or a radio receiver. The audio content can be represented on a display screen with an icon. Generally, the icon must be custom made or chosen from a plurality of default icons in the interactive system. Typically, in current interactive systems, there is no way of graphically indicating a stored, downloading, or playing audio content to a user where the graphic indication is specifically related to the audio content.

Therefore it is an object of the present invention to provide methods and interactive systems that overcome these and other disadvantages associated with the prior art.

Accordingly, a method for displaying a pictorial item corresponding to an audio content item is provided. The method comprising: identifying one or more characteristics of the audio content item; searching a first remote network for the corresponding pictorial item based on the identified one or more characteristics; retrieving the corresponding pictorial item from the first remote network; and

displaying the pictorial item corresponding to the audio content item.

The identifying can comprise: searching the audio content item for a portion containing the one or more characteristics; and retrieving the one or more characteristics from the portion. The portion can comprise an ID3 tag.

The identifying can comprise: searching a second remote network for the one or more characteristics corresponding to the audio content item; and retrieving the one or more characteristics from the second remote network. The second remote network can contain a database having a plurality of audio content items and one or more corresponding characteristics for each of the plurality of audio content items. The identifying can also comprise analyzing the audio content item to obtain an audio fingerprint containing the one or more characteristics.

The displaying can comprise downsizing the pictorial item into a thumbnail icon at one of prior to the retrieving and subsequent to the retrieving. The downsizing can further comprise reducing a resolution of the pictorial item at one of prior to the retrieving and subsequent to the retrieving.

The method can further comprise storing the pictorial item subsequent to the retrieving.

The identifying can be initiated automatically upon occurrence of an event. The event can be one of storing the audio content item, playing the audio content item, receiving a transmission of the audio content item, and downloading the audio content item. The identifying can also be initiated by a manual indication from a user.

The displaying can be initiated automatically upon occurrence of an event. The event can be one of storing the audio content item, playing the audio content item, receiving a transmission of the audio content item, and downloading the audio content item. The displaying can also be initiated by a manual indication from a user.

The pictorial item can be a CD cover corresponding to at least the audio content item.

The audio content item can be a song track from a plurality of song tracks corresponding to the CD cover and the displaying can further comprise altering the CD cover to indicate the song track. The altering can comprise displaying a numerical value with the CD cover, the numerical value indicating a song track number of the song track.

Also provided is an apparatus for displaying a pictorial item corresponding to an audio content item. The apparatus comprising: a modem operatively connected with a remote network; a processor for identifying one or more characteristics of the audio content item; searching the remote network for the corresponding pictorial item based on the identified one or more characteristics; and retrieving the corresponding pictorial item from the first remote network; and a display for displaying the pictorial item corresponding to the audio content item.

Also provided are a computer program product for carrying out the methods of the present invention and a program storage device for the storage of the computer program product therein.

These and other features, aspects, and advantages of the apparatus and methods of the present invention will become better understood with regard to the following description, appended claims, and accompanying drawings where:

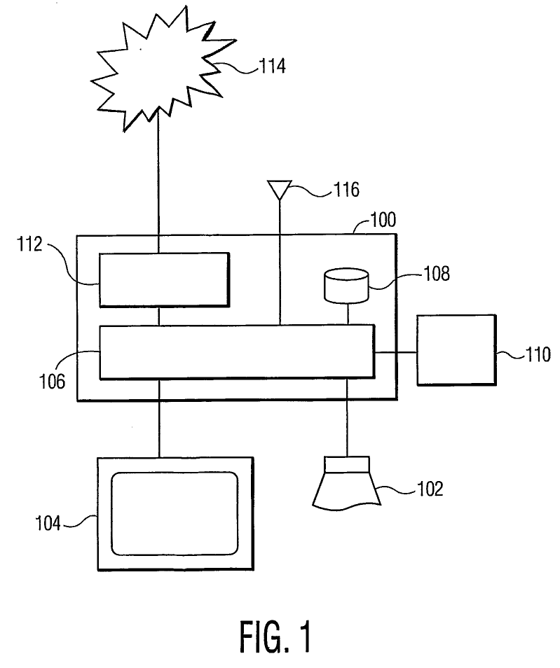

FIG. 1 illustrates a schematic illustration of an embodiment of an apparatus according to the present invention.

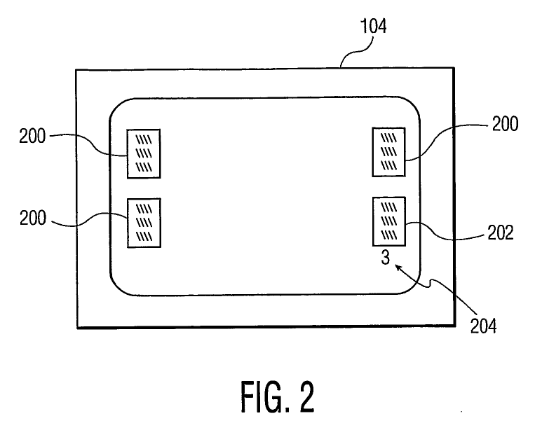

FIG. 2 illustrates a display from the apparatus of FIG. 1.

Although this invention is applicable to numerous and various types of apparatus and audio content items, it has been found particularly useful in the environment of songs. Therefore, without limiting the applicability of the invention to songs, the invention will be described in such environment. Those skilled in the art will also appreciate that the audio content items can be speeches, spoken novels and the like.

Referring now to FIG. 1, an apparatus for displaying a pictorial item corresponding to an audio content item is shown, the apparatus being generally referred to by reference numeral 100. Those skilled in the art will appreciate that the apparatus can be any device capable of reproducing audio content items and displaying a representative pictorial item. Examples of such apparatus 100 include but is not limited to a personal computer, a laptop computer, and audio content players such as a CD player, MP3 player, a personal digital assistant, and a radio receiver. The apparatus 100 generally includes one or more speakers 102 for reproducing the audio content item and a display 104. As will be discussed below, the display 104 is capable of displaying a pictorial item that is representative of an audio content item, such as a corresponding CD cover. The display 104 can be dedicated to such a function or perform other functions of the apparatus 100.

The apparatus further has a processor 106 for carrying out the methods of the present invention. The processor 106 may be dedicated to such functions or perform other functions of the apparatus 100. The processor 106, either directly or indirectly through appropriate drivers, controls the speaker(s) 102 and display 104. The apparatus 100 further has a storage device 108, such as a memory operatively connected to the processor for storing the audio content items. The storage device 108 may also store program instructions for carrying out the methods of the present invention as well as for carrying out other functions of the apparatus 100. Although, the storage device 108 is shown in FIG. 1 as a single unit, those skilled in the art will appreciate that it can be provided in multiple units and in different types of storage devices. For example, the storage device 108 may be implemented as a hard drive for storing the audio content items and an integrated chip for storing program instructions.

The apparatus further can include an input device 110 for inputting data or instructions to the processor 106. The input device 110 can be any input device known in the art, such as a keyboard/keypad, a mouse, a stylus pen, a rollerball, a speech recognition system, a touch screen, one or more switches/button pads, a connector for uploading audio content items from other devices, such as an MP3 player, and a CD/DVD drive. The apparatus 100 also includes a communication device 112, such as a modem under the control of the processor 106 and operatively connected to a remote network 114, such as the Internet. The apparatus 100 can also include a radio receiver, shown schematically by antenna 116. The radio receiver is under the control of the processor and configured to receive, demultiplex, and/or format any type of radio transmission known, such as FM, AM, cable, and satellite.

Methods for displaying a pictorial item corresponding to an audio content item will now be described with regard to FIGS. 1 and 2. The methods assume, unless otherwise noted, that the audio content items are available to the apparatus 100, either by the input device 110, the remote network 114, or the radio receiver 116. The method identifies one or more characteristics of the audio content item. The one or more characteristics can be an author of the song, a performer of the song, a title of the song, a corresponding album (CD) of which the song is a part, the year the song was released, a genre of the song and the like.

After the one or more characteristics are identified, the apparatus searches the remote network 114 for a corresponding pictorial item based on the identified one or more characteristics. Specifically, the processor 106 instructs the modem to contact the remote network, retrieve the corresponding pictorial item from the remote network 114, and display the pictorial item corresponding to the audio content item on the display 104. The remote network 114 can be the Internet, and more specifically, a web site having an address on the Internet where a database of pictorial items, such as CD covers are stored for downloading. Such an Internet web site is www.cover-search.com. For example, the one or more characteristics identified can be the song title and artist of the audio content item. The processor 106 can contact www.cover-search.com via the modem 112 and supply the song title and artist for a search of the database. The processor would then retrieve a CD cover corresponding to the search results. If the search results in more than one CD cover, more characteristics can be supplied to narrow the search or all of the CD covers resulting from the search can be retrieved and the user of the apparatus 100 can choose among the CD covers retrieved for display. The displayed CD cover can then serve as a link to the reproduction of the corresponding audio content item.

The identification of the characteristics of the audio content item can comprise searching the audio content item itself for a portion containing the characteristics and retrieving the characteristics from the portion. The portion of the audio content item can be an ID3 tag. An ID3 tag is 128 bytes of data added to the end of an audio content file. The ID3 tag contains 3 bytes of the word “tag,” 30 bytes for the song title, 30 bytes for the artist, 30 bytes for the name of the corresponding album, 4 bytes for the year of release, 30 bytes for comments, and 1 byte for genre. Bytes not used are filled with a binary 0 value. Also, the genre field contains a value that corresponds to a predefined list of 80 genres (values 0-79). Where the audio content item contains such a tag, the processor 106 searches the audio content item for the tag. Where the tag is an ID3 tag, the processor 106 would look for the word “tag” 128 bytes from the end of the audio content file. The processor 106 would then retrieve the characteristics in each of the fields and use the same to search the remote network 114 for a corresponding pictorial item. As discussed above, the search can start using any one or combination of the characteristics, such as song title and artist. Any of the other characteristics identified can be added to the search should the search result in no or more than one result.

The identification of the characteristics of the audio content item can also comprise searching a remote network 114 (different or the same as the remote network used to search for the pictorial item) for the one or more characteristics corresponding to the audio content item and retrieving the one or more characteristics from the remote network 114. In this case, the remote network can contain a database of a plurality of audio content items and one or more corresponding characteristics for each of the plurality of audio content items in the database. The remote network can be an Internet web site, such as www.musicbrainz.org. Such web sites contain a database of music metadata that can be used to identify audio content items. In this situation, the processor 106 contacts the remote network via the modem 112 to determine one or more characteristics of the audio content item and retrieves any results from the web site. The processor would then use the same to search the remote network 114 for a corresponding pictorial item similarly to that described above.

The identification of the characteristics of the audio content item can also comprise analyzing the audio content item itself to obtain an audio fingerprint containing the one or more characteristics. Such audio fingerprinting is known in the art such as that disclosed in J. A. Haitsma, Ton Kalker, “A highly robust audio fingerprinting system”, 2002, IRCAM; and T. Kalker, “Applications and Challenges for Audio Fingerprinting”, presentation at the 111th AES Convention, N.Y., in the “Watermarking versus Fingerprinting” workshop, Dec. 3, 2001, the disclosures of which are incorporated herein by their reference.

As discussed above, the pictorial item, such as a CD cover is displayed on the display 104 to represent the audio content item. Such CD covers are often available in full size and at high resolution for printing. In such instances, it may be desirable to downsize the pictorial item into a thumbnail icon either prior to being retrieved from the remote network 114 or subsequent to the retrieving by the processor 106. Furthermore, the downsizing can also include reducing the resolution of the pictorial item before displaying it on the display 104. Similarly to the downsizing, the reduction in resolution can be done either prior to being retrieved from the remote network 114 or subsequent to the retrieving by the processor 106. The pictorial item can be retrieved and displayed on the display 106 without being saved to the memory 108, such as when a song is being played on a radio apparatus 100. Alternatively, the pictorial item can be retrieved and stored in the memory 108 subsequent to the retrieving. In the latter, the pictorial item is always available for display.

The identification process can be initiated automatically upon occurrence of an event, such as storing the audio content item in the memory 108, playing the audio content item on the speaker 102, receiving a transmission of the audio content item from the antenna 116 (or other transmission means), and downloading the audio content item from the remote network 114. Alternatively, the identification process can be initiated by a manual indication from a user, such as through the input device 110. The displaying of the pictorial item can also be initiated automatically upon occurrence of an event, such as storing the audio content item in the memory 108, playing the audio content item on the speaker 102, receiving a transmission of the audio content item from the antenna 116 (or other transmission means), and downloading the audio content item from the remote network 114. The displaying of the pictorial item can also be initiated by a manual indication from a user, such as through the input device 110. For example, if a command is received by the processor 106 to download an audio content item, such as a song from the Internet 114, the commencement of the download can initiate both the identification of one or more characteristics of the audio content item, and the displaying of a representative pictorial item found as a result of the identification of the characteristics. Similarly, if a command is received by a processor to tune to a certain frequency and an audio content item, such as a song, is being transmitted on that frequency and reproduced on the speaker 102, the reproduction (playing) of the audio content item can initiate the indication and display processes as described above.

Where the audio content item is a song track from a plurality of song tracks contained on an album, an indication can be displayed with the pictorial item to identify the song track and to distinguish it from the other song tracks on the album. Each song track on an album may not have a corresponding pictorial item. All song tracks identified with an album may only have a single representative pictorial item, such as a CD cover. Therefore, the methods of the present invention can alter the CD cover to indicate the song track. Referring now to FIG. 2, there is shown the display 104 of FIG. 1 having pictorial items 200 corresponding to audio content items. The display 104 further has a pictorial item 202 as a CD cover in which the same is altered to indicate the song track from the corresponding album. As shown in FIG. 2 by pictorial item 202, the altering can comprise displaying a numerical value 204 with the CD cover where the numerical value indicates a song track number of the song track. For example, where the audio content item is the third song track of an album, the pictorial item 202 can be altered to overlay a number “3” on at least a portion of the pictorial item 202. The numerical value 204 can be positioned anywhere within the pictorial item 202 and can also be positioned outside the pictorial item 202. Those skilled in the art will appreciate that other types of alteration can be made to the pictorial item 202 to indicate the particular song track from among a plurality of song tracks on an album, such as a title or abbreviated version of the title or an additional pictorial item.

The methods of the present invention are particularly suited to be carried out by a computer software program, such computer software program preferably containing modules corresponding to the individual steps of the methods. Such software can of course be embodied in a computer-readable medium, such as an integrated chip or a peripheral device.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

1. A method for displaying a pictorial item corresponding to an audio content item, the method comprising:
identifying one or more characteristics of the audio content item;
searching a first remote network (114) for the corresponding pictorial item based on the identified one or more characteristics;
retrieving the corresponding pictorial item from the first remote network; and
displaying the pictorial item corresponding to the audio content item.

2. The method of claim 1, wherein the identifying comprises:
searching the audio content item for a portion containing the one or more characteristics; and
retrieving the one or more characteristics from the portion.

3. The method of claim 2, wherein the portion comprises an ID3 tag.

4. The method of claim 1, wherein the identifying comprises:
searching a second remote network (114) for the one or more characteristics corresponding to the audio content item; and
retrieving the one or more characteristics from the second remote network.

5. The method of claim 4, wherein the second remote network contains a database having a plurality of audio content items and one or more corresponding characteristics for each of the plurality of audio content items.

7. The method of claim 1, wherein the identifying comprises analyzing the audio content item to obtain an audio fingerprint containing the one or more characteristics.

8. The method of claim 1, wherein the displaying comprises downsizing the pictorial item into a thumbnail icon (200, 202) at one of prior to the retrieving and subsequent to the retrieving.

9. The method of claim 7, wherein the downsizing further comprises reducing a resolution of the pictorial item at one of prior to the retrieving and subsequent to the retrieving.

10. The method of claim 1, further comprising storing the pictorial item subsequent to the retrieving.

11. The method of claim 1, wherein the identifying is initiated automatically upon occurrence of an event.

12. The method of claim 10, wherein the event is one of storing the audio content item, playing the audio content item, receiving a transmission of the audio content item, and downloading the audio content item.

13. The method of claim 1, wherein the identifying is initiated by a manual indication from a user.

14. The method of claim 1, wherein the displaying is initiated automatically upon occurrence of an event.

15. The method of claim 13, wherein the event is one of storing the audio content item, playing the audio content item, receiving a transmission of the audio content item, and downloading the audio content item.

16. The method of claim 1, wherein the displaying is initiated by a manual indication from a user.

17. The method of claim 1, wherein the pictorial item is a CD cover corresponding to at least the audio content item.

18. The method of claim 1, wherein the audio content item is a song track from a plurality of song tracks corresponding to the CD cover and wherein the displaying further comprises altering the CD cover to indicate the song track.

19. The method of claim 18, wherein the altering comprises displaying a numerical value (204) with the CD cover, the numerical value indicating a song track number of the song track.

20. A computer program product embodied in a computer-readable medium for displaying a pictorial item corresponding to an audio content item, the computer program product comprising:
computer readable program code means for identifying one or more characteristics of the audio content item;
computer readable program code means for searching a remote network (114) for the corresponding pictorial item based on the identified one or more characteristics;
computer readable program code means for retrieving the corresponding pictorial item from the remote network; and
computer readable program code means for displaying the pictorial item corresponding to the audio content item.

21. An apparatus (100) for displaying a pictorial item corresponding to an audio content item, the apparatus comprising:
a modem (112) operatively connected with a remote network (114);
a processor (106) for identifying one or more characteristics of the audio content item; searching the remote network for the corresponding pictorial item based on the identified one or more characteristics; and retrieving the corresponding pictorial item from the remote network; and
a display (104) for displaying the pictorial item corresponding to the audio content item.
